(19) United States
(12) Patent Application Publication
(10) Pub. No.: US 2022/0389815 A1
(43) Pub. Date: Dec. 8, 2022

(54) TUNNEL SURROUNDING ROCK SUPPORTING METHOD AND SYSTEM BASED ON TUNNEL FIELD DECONSTRUCTION AND RECONSTRUCTION THEORY

(71) Applicants: China Railway Tunnel Group Co., Ltd., Guangzhou (CN); China Railway Tunnel Co., Ltd., Zhengzhou (CN)

(72) Inventors: Kairong HONG, Guangzhou (CN); Weishe GUO, Guangzhou (CN); Huanhuan FENG, Guangzhou (CN); Yi ZHAO, Zhengzhou (CN); Yongsheng LIU, Guangzhou (CN); Jinhu YOU, Zhengzhou (CN); Jingzhao SI, Guangzhou (CN); Chaoshuai YANG, Guangzhou (CN); Pan GAO, Guangzhou (CN); Luwei YANG, Guangzhou (CN); Qi WANG, Zhengzhou (CN); Junge HUANG, Zhengzhou (CN); Jiawu YU, Guangzhou (CN)

(73) Assignees: China Railway Tunnel Group Co., Ltd., Guangzhou (CN); China Railway Tunnel Co., Ltd., Zhengzhou (CN)

(21) Appl. No.: 17/834,104

(22) Filed: Jun. 7, 2022

Related U.S. Application Data
(63) Continuation of application No. PCT/CN2021/112242, filed on Aug. 12, 2021.

(30) Foreign Application Priority Data
Jun. 4, 2021 (CN) 2021106265256

(51) Int. Cl. E21D 9/01; E21D 9/00; G06F 30/13

(52) U.S. Cl. CPC E21D 9/01; E21D 9/001; G06F 30/13

(57) ABSTRACT

The present invention belongs to the technical field of tunnel surrounding rock supports and discloses a tunnel surrounding rock supporting method and system based on a tunnel field deconstruction and reconstruction theory. The tunnel surrounding rock supporting method based on the tunnel field deconstruction and reconstruction theory comprises the following steps: establishment of a tunnel field, deconstruction of the tunnel field and reconstruction of the tunnel field. In the tunnel surrounding rock supporting method based on the tunnel field deconstruction and reconstruction theory provided by the invention, through reconstruction of the tunnel field, the energy storage capacity of a rock and soil mass can be improved.

### CROSS-REFERENCE TO RELATED APPLICATIONS

The application claims priority to Chinese patent application No. 2021106265256, filed on Jun. 4, 2021, the entire contents of which are incorporated herein by reference.

### TECHNICAL FIELD

The present invention belongs to the technical field of tunnel surrounding rock supports and particularly relates to a tunnel surrounding rock supporting method and system based on a tunnel field deconstruction and reconstruction theory.

### BACKGROUND

At present, with increasing prosperity of our country, various constructions rapid develop and are booming, and more and more underground engineering such as large deep mine roadways and deeply-buried long tunnels have already been or will be incorporated into national major project planning; wherein there will be many problems when the underground engineering such as large deeply-buried long tunnels are constructed at places with complex topographic, geomorphic and geological conditions; for example, bad geological conditions such as increase in ground stress, head pressure and ground temperature increase a speed of destroying tunnels with the complex geological conditions, and the tunnels deform severely, followed by increase in the amount of fractured rock masses. In order to effectively prevent accidents such as roof collapse of the tunnels and caving of the fractured rock masses, the use amount of devices in a tunnel supporting operation is huge. However, in the actual tunnel supporting construction process, the flexibility and the reliability of the traditional tunnel surrounding rock supporting method are poorer; and in the idea of the traditional new Austria tunneling method, the traditional load-structure model and the traditional stratum structure model have been difficult to meet the tunneling requirement under the complex geological conditions.

Based on the above analysis, the prior art has the problems and defects that: the idea of the new Austria tunneling method: the self bearing capacity of surrounding rocks is exerted as a core, and a reasonable supporting opportunity is determined according to a surrounding rocks versus supporting characteristic curve, so that supporting parameters are optimized and the cost is saved; and the disadvantages are: the supporting opportunity is very difficultly determined and is difficultly controlled during construction, the uncertainty of physico-mechanical parameters of the surrounding rocks greatly affects a design on the supporting parameters. This problem remains very prominent at present.

The load-structure model: a load of the surrounding rocks is determined through different methods (such as the Terzaghi load-structure model, the Coulomb soil pressure model and an experiential formula) and is applied to a supporting structure, an internal force of the structure is calculated, and then a design and optimization on the structure are achieved; and the disadvantages are: a method of determining the load remains immature, an error on the load is relatively large, and a calculation result is greatly affected.

The stratum structure method: a surrounding rock stratum and the supporting structure are considered as two jointly acting structure systems; the load of the surrounding rocks acts on the supporting structure; and the supporting structure has a resistance to the surrounding rocks in one direction after deforming until a balance state between stresses on both the surrounding rocks and the supporting structure is achieved. In the stratum structure method, a stress release rate greatly affects the design and optimization on the structure; it is difficult to test or control the stress release rate in the engineering circle at present; and therefore, the stratum structure method is less applied in actual engineering.

The difficulty to solve the above problems and detects is that the rigidity of the surrounding rocks is difficultly established, and a test for an energy field and a quantitative model for deterioration of a surrounding rock medium are relatively difficult.

The significance of solving the above problems and defects is that due to perception on the uncertainty of the rock and soil mass plus the variability of the rock and soil mass in the construction process, it is unrealistic to contemplate to solve the problems in tunnel engineering by using a pure mechanics method.

The deconstruction and reconstruction idea: the surrounding rocks and the support are considered as a whole system, the support only serves as a component in this system, and thus the deconstruction and reconstruction idea is different from the traditional tunnel design idea and method. The deconstruction and reconstruction idea does not have high sensitivity to the physico-mechanical parameters of the surrounding rocks, does not require accurate parameters of the surrounding rocks, has no strict requirement for the supporting opportunity, mainly adjusts the parameters of the support through information monitoring data to improve the whole rigidity of the surrounding rocks and thus is conveniently applied to construction.

### SUMMARY

Aiming to the problems in the prior art, the present invention provides a tunnel surrounding rock supporting method and system based on a tunnel field deconstruction and reconstruction theory. Therefore, the active supporting idea of “taking an anchor as a major and actively controlling deformation” is formed; and a great transfer of the idea of the new Austria tunneling method to the deconstruction and reconstruction theory of cooperative supporting is achieved.

The present invention is implemented in such a way that the tunnel surrounding rock supporting method based on the tunnel field deconstruction and reconstruction theory comprises the following steps:

step 1, establishment of a tunnel field;

step 2, deconstruction of the tunnel field; and

step 3, reconstruction of the tunnel field.

Further, in step 1, establishment of a tunnel field comprises:

by considering a tunnel as a portion of a rock and soil mass, concepts of a “load” and “surrounding rocks” are weakened, and then a concept of the tunnel field based on a geological domain is proposed.

The present invention proposes the concept of the “tunnel field”: a region, in which the rock and soil mass (dielectric field) and a stress environment (stress field) within a certain range at the periphery of a tunnel are superposed, is defined as the tunnel field: it is proposed that formation of the tunnel is a process of field state adjustment of deconstruction (excavation) and reconstruction (supporting) of the tunnel field; and it is indicated that adjustment on the stress field and improvement in the dielectric field are major means for field state adjustment.

Further, in step 2, deconstruction of the tunnel field comprises:

(1) deterioration of the properties of the soil mass;

(2) adjustment on the soil stress;

(3) energy conversion to the internal consumed energy, irreversible;

(4) energy conversion to the deformation energy, or energy absorption by the support body; and

(5) rock mass storage.

Further, in step 2, deconstruction of the tunnel field comprises:

(1) deterioration of the rock and soil mass in the tunnel field:

due to the uncertainty of perception on the rock and soil mass in the tunnel field, after the rock and soil mass is excavated, both a stress state and the properties of the rock and soil mass in the field are changed; and in addition, such changes further have variability due to different excavation methods;

(2) stress adjustment in the tunnel field; and

(3) change on an energy storage capacity of the tunnel field:

surrounding rocks deform due to deconstruction of the tunnel field, and the phenomena of energy accumulation and release exist before and after deformation of the surrounding rocks; and a stress state is transited to a two-dimensional stress state from a three-dimensional stress state, which causes that a great quantity of deformation energy of the rock and soil mass in the tunnel field is released.

Further, in step 3, the reconstruction of the tunnel field further comprises:

(1) energy is converted to the internal consumed energy-irreversible, naturally released;

(2) after rock mass stored energy-tunnel field is deconstructed, according to the property condition of the rock and soil mass, a part of the energy is continuously stored in the rock and soil mass, and all the rest requires to be released, that is, is converted to the deformation energy or is absorbed by the support body; and

(3) a supporting system is guaranteed to absorb excess energy and be stable; supporting method; a steel arch and reinforcement rows.

The reconstruction of the tunnel field further comprises:

(1) active supporting:

a two-dimensional stress field is reconstructed into a three-dimensional stress field;

the rock and soil mass in the tunnel field is improved, and deformation moduli c, φ and E as the physico-mechanical properties are strengthened;

(2) change on the stored energy of the rock and soil mass in the tunnel field:

according to the related theory of rock and soil mechanics, a total energy of the rock and soil mass in the tunnel field is and a following formula is obtained according to the stress environment, in which a rock and soil mass unit is located:

Uₑ=½σ₁●ε₁^{e}+½σ₂●ε₂^{e}+½σ₃●ε₃^{e};

(3) energy balance:

energy changes caused by deconstruction and reconstruction of the tunnel field comprise:

1) the internal consumed energy of the rock and soil mass is U_{d} and is irreversible;

2) for the deformation energy of the rock and soil mass in the tunnel field, under the synergistic effect of the support body, a part of the deformation energy is absorbed and digested by the support body:

U_{support body}=ΣₗⁿUᵢ^{e};

3) the rest deformation energy is stored in the rock and soil mass in the tunnel field U′ₑ.

U′ₑ=½σ′₁●ε₁^{e}+½σ₂●ε₂^{e}+½σ₃●ε₃^{e};

4) according to the energy balance principle:

Uₑ=U_{d}+U_{support body}+Uₑ

Another purpose of the present invention is to provide the tunnel surrounding rock supporting system based on the tunnel field deconstruction and reconstruction theory applying the tunnel surrounding rock supporting method based on the tunnel field deconstruction and reconstruction theory, comprising:

a tunnel field establishing module for considering a tunnel as a portion of a rock and soil mass, weakening concepts of a “load” and “surrounding rocks”, and then proposing a concept of the tunnel field based on a geological domain;

a tunnel field deconstruction module for conducting deterioration of properties of a soil mass, adjustment on soil stress, energy conversion to internal consumed energy and deformation energy, energy absorption by a support body and rock mass storage; and

a tunnel field reconstruction module for conducting reconstruction of the tunnel field, comprising active supporting, determination of a change of a stored energy of the rock and soil mass in the tunnel field and energy balance.

Another purpose of the present invention is to provide a computer readable storage medium, in which instructions are stored. When the instruction is operated on a computer, the computer applies the tunnel surrounding rock supporting system based on the tunnel field deconstruction and reconstruction theory.

Another purpose of the present invention is to provide an information data processing terminal. The information data processing terminal is used for implementing the tunnel surrounding rock supporting system based on the tunnel field deconstruction and reconstruction theory.

In combination with all the above technical solutions, the present invention has the following advantages and positive effects: in the tunnel surrounding rock supporting method based on the tunnel field deconstruction and reconstruction theory provided by the present invention, by considering a tunnel as a portion of a rock and soil mass, concepts of a “load” and “surrounding rocks” are weakened, and then a concept of the tunnel field based on a geological domain is proposed. Through reconstruction of the tunnel field, the present invention has a control purpose of improving the energy storage capacity of the rock and soil mass and reducing the energy required to be absorbed by a support body as much as possible, improves the energy storage capacity of the rock and soil mass in the tunnel field to guarantee that the supporting system can absorb excess energy and is stable and achieves the purpose of lowering the energy release rate of the tunnel field and reducing the energy absorbed by “an arch frame plus shotcrete”. Meanwhile, active supporting provided by the present invention enables the energy storage capacity of the rock and soil mass to be significantly improved so as to lower the energy release rate of deconstruction of the tunnel field and thus is a major technical means of controlling deformation of the tunnel within an allowable range.

### BRIEF DESCRIPTION OF DRAWINGS

FIG. 1 is a flow chart of a tunnel surrounding rock supporting method based on a tunnel field deconstruction and reconstruction theory according to the embodiment of the present invention.

FIG. 2 is a structural block diagram of a tunnel surrounding rock supporting system based on a tunnel field deconstruction and reconstruction theory according to the embodiment of the present invention.

FIG. 3 is a structural schematic diagram of a tunnel field according to the embodiment of the present invention.

FIG. 4 is a schematic diagram of stress adjustment after a tunnel is excavated according to the embodiment of the present invention.

FIG. 5 is a schematic diagram of reconstruction of a tunnel field according to the embodiment of the present invention.

FIG. 6 is an implementation effect data diagram I of a pre-stressed anchor cable in a certain section according to the embodiment of the present invention. In FIG. 6: cross section: YK218+413.6; a length of the anchor cable is 10.3 m; a circumferential interval of the anchor cable is 1 m; and a unit of a drawing force is ton.

FIG. 7 is an implementation effect data diagram II of a pre-stressed anchor cable in a certain section according to the embodiment of the present invention. In FIG. 7: cross section: YK218+414.2; a length of the anchor cable is 5.3 m; a circumferential interval of the anchor cable is 1 m; and a unit of a drawing force is ton.

FIG. 8 is a monitoring data diagram I of construction anchor cable section YK218+455 in Muzhailing Tunnel of Wei-Wu Railway according to the embodiment of the present invention.

FIG. 9 is a monitoring data diagram II of construction anchor cable section YK218+455 in Muzhailing Tunnel of Wei-Wu Railway according to the embodiment of the present invention.

FIG. 10 is an effect diagram of a load-structure theoretical method in prior art according to the embodiment of the present invention. In FIG. 10, an arch frame is twisted.

FIG. 11 is an effect diagram of using a technical system of “anchoring followed by supporting plus active deformation control” of the present invention according to the embodiment of the present invention. In FIG. 11, clearance intrusion does not occur.

### DETAILED DESCRIPTION OF THE EMBODIMENTS

Aiming to the problems in the prior art, the present invention provides a tunnel surrounding rock supporting method and system based on a tunnel field deconstruction and reconstruction theory. The present invention is described in detail below in combination with the accompany drawings.

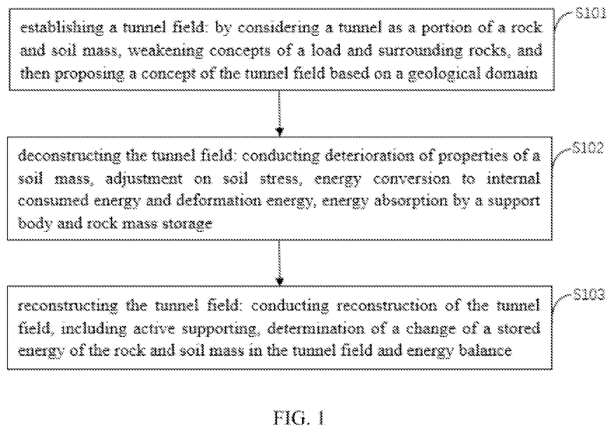

As shown in FIG. 1, the tunnel surrounding rock supporting method based on the tunnel field deconstruction and reconstruction theory according to the embodiment of the present invention comprises the following steps:

S101, establishment of a tunnel field: by considering a tunnel as a portion of a rock and soil mass, concepts of a load and surrounding rocks are weakened, and then a concept of the tunnel field based on a geological domain is proposed;

S102, deconstruction of the tunnel field: deterioration of properties of a soil mass, adjustment on soil stress, energy conversion to internal consumed energy and deformation energy, energy absorption by a support body and rock mass storage are conducted; and

S103, reconstruction of the tunnel field: reconstruction of the tunnel field, including active supporting, determination of a change of a stored energy of the rock and soil mass in the tunnel field and energy balance, is conducted.

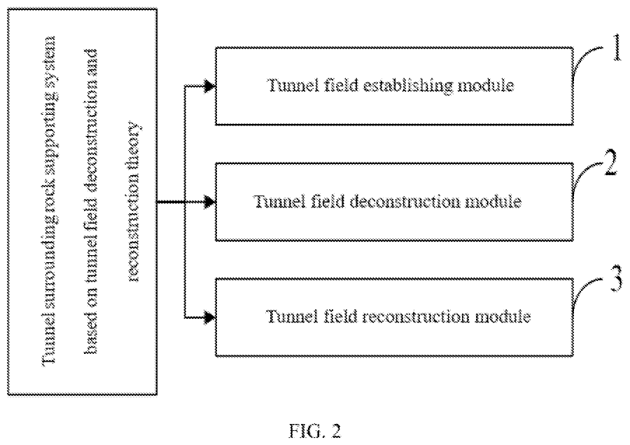

As shown in FIG. 2, the tunnel surrounding rock supporting system based on the tunnel field deconstruction and reconstruction theory according to the embodiment of the present invention comprises:

a tunnel field establishing module 1 for considering a tunnel as a portion of a rock and soil mass, weakening concepts of a “load” and “surrounding rocks” and then proposing a concept of the tunnel field based on a geological domain;

a tunnel field deconstruction module 2 for conducting deterioration of properties of a soil mass, adjustment on soil stress, energy conversion to internal consumed energy and deformation energy, energy absorption by a support body and rock mass storage; and

a tunnel field reconstruction module 3 for conducting reconstruction of the tunnel field, including conducting active supporting, determination of a change of a stored energy of the rock and soil mass in the tunnel field and energy balance.

The technical solutions of the present invention are further described below in combination with the embodiments.

### Embodiment

By considering a tunnel as a portion of a rock and soil mass, the present invention weakens concepts of a “load” and “surrounding rocks” and then proposes a concept of the tunnel field based on a geological domain, specifically:

1. Proposition of a definition of a tunnel field:

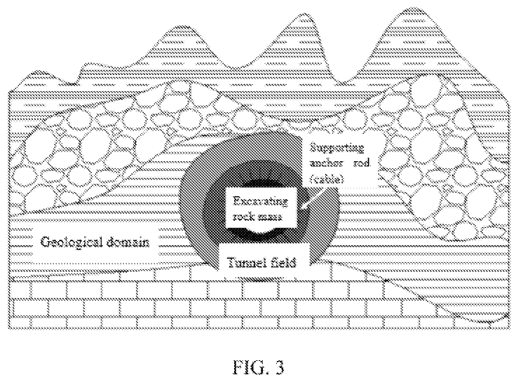

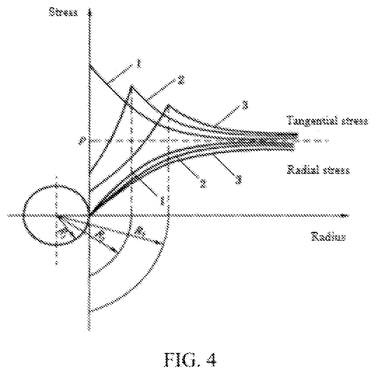

As shown in FIG. 3, the tunnel is a space which is formed by excavating a part of rock and soil masses from a geological domain and supplied to humans to use. In this process, the stress state and the properties of rock and soil masses within a certain range in the original geological domain are changed, and then the tunnel field is formed; wherein a schematic diagram of stress adjustment after the tunnel is excavated is shown in FIG. 4.

2. Deconstruction steps of the tunnel field (deterioration of properties of a soil mass, adjustment on soil stress, energy conversion to internal consumed energy (irreversible) plus deformation energy (absorbed by a support body) and rock mass storage):

(1) Deterioration of the rock and soil mass in the tunnel field

Due to the uncertainty of perception on the rock and soil mass in the tunnel field, after the rock and soil mass is excavated, both a stress state and the properties of the rock and soil mass in the field arc changed; and in addition, such changes further have variability due to different excavation methods.

With excavation of the tunnel, the physico-mechanical properties of surrounding rocks are necessarily changed.

(2) Stress adjustment in the tunnel field

(3) Change on the energy storage capacity of the tunnel field

Surrounding rocks deform due to deconstruction of the tunnel field, and the phenomena of energy accumulation and release exist before and after deformation of the surrounding rocks; and a stress state is transited to a two-dimensional stress state from a three-dimensional stress state, which causes that a great quantity of deformation energy of the rock and soil mass in the tunnel field is released.

3. Reconstruction purpose and method of the tunnel field: (1) energy is converted to the internal consumed energy-irreversible, naturally released. (2) After rock mass stored energy-tunnel field is deconstructed, according to the property condition of the rock and soil mass, a part of the energy is continuously stored in the rock and soil mass, and all the rest requires to be released, that is, is converted to the deformation energy or is absorbed by the support body; and therefore, it is a control purpose that the energy storage capacity of the rock and soil mass is improved, and the energy required to he absorbed by the support body is reduced as much as possible. A method of improving the energy storage capacity of the rock and soil mass in the tunnel field is-measures of grouting, an anchor rod, an anchor cable and the like. (3) A supporting system is guaranteed to absorb excess energy and be stable; supporting method; a steel arch, reinforcement rows and the like.

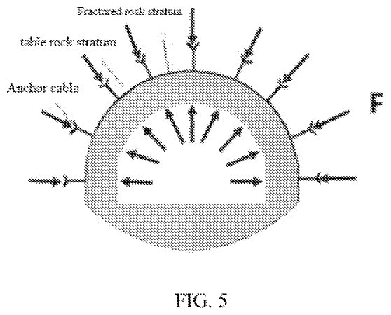

As shown in FIG. 5, the effect of a pre-stressed anchor rod (cable) is taken as an example.

(1) Active supporting:

1) in an aspect, a two-dimensional stress field is reconstructed into a three-dimensional stress field as soon as possible;

2) in another aspect, the rock and soil mass in the tunnel field is improved, the physico-mechanical properties (such as deformation moduli c, φ and E) of the rock and soil mass are strengthened, and the energy storage capacity of the tunnel field is improved; and

3) the purpose of lowering the energy release rate of the tunnel field and reducing the energy absorbed by “an arch frame plus shoterete” is achieved.

(2) Change on the stored energy of the rock and soil mass in the tunnel field:

According to the related theory of rock and soil mechanics, a total energy of the rock and soil mass in the tunnel field is Uₑ, and a following formula is obtained according to the stress environment, in which a rock and soil mass unit is located:

Uₑ=½σ₁●ε₁^{e}+½σ₂●ε₂^{e}+½σ₃●ε₃^{e};

active supporting enables the energy storage capacity of the rock and soil mass to be significantly improved so as to lower the energy release rate of deconstruction of the tunnel field and thus is a major technical means of controlling deformation of the tunnel within an allowable range.

(3) Energy balance:

Energy changes caused by deconstruction and reconstruction of the tunnel field

1) the internal consumed energy of the rock and soil mass is U_{d}: for example, the consumed energy caused by rock fractures, crack development and extension and the like; and this part of energy is irreversible;

2) for the deformation energy of the rock and soil mass in the tunnel field, under the synergistic effect of the support body, a part of the deformation energy is absorbed and digested by the support body:

U_{support body}=σₗⁿUᵢ^{e};

3) the rest deformation energy is stored in the rock and soil mass in the tunnel field U′ₑ:

U′ₑ=½σ′₁●ε₁^{e}+½σ₂●ε₂^{e}+½σ₃●ε₃^{e}; and

4) according to the energy balance principle:

Uₑ=U_{d}+U_{support body}+U′ₑ

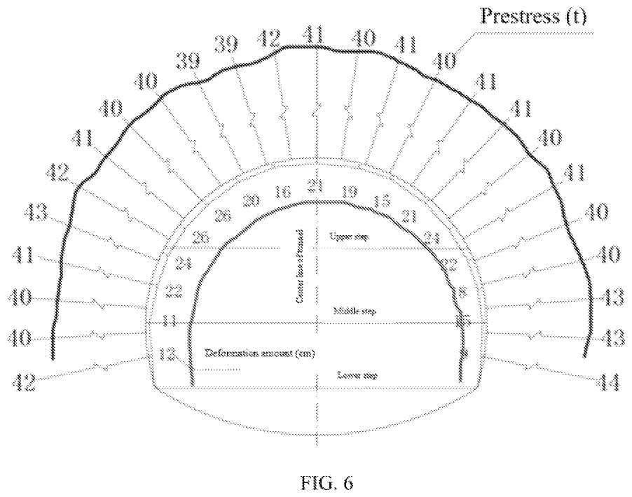

By using the method of the present invention, in application of Muzhailing Tunnel of Wei-Wu Railway, implementation effect data of a pre-stressed anchor cable in a certain section is shown as a cross section of FIG. 6: YK218+413.6; a length of the anchor cable is 10.3 m; a circumferential interval of the anchor cable is 1 m; and a unit of a drawing force is ton.

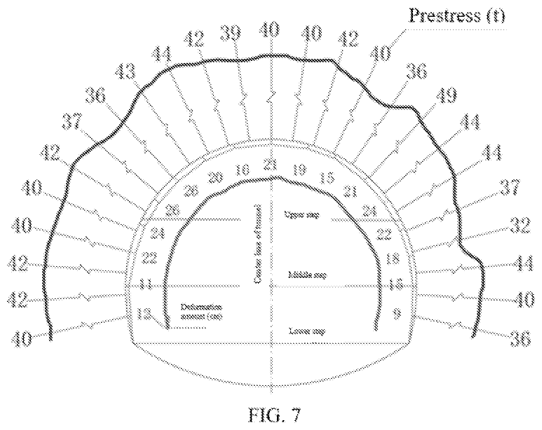

FIG. 7 is diagram showing that a cross section: YK218+414.2; a length of the anchor cable is 5.3 m; a circumferential interval of the anchor cable is 1 m; and a unit of a drawing force is ton.

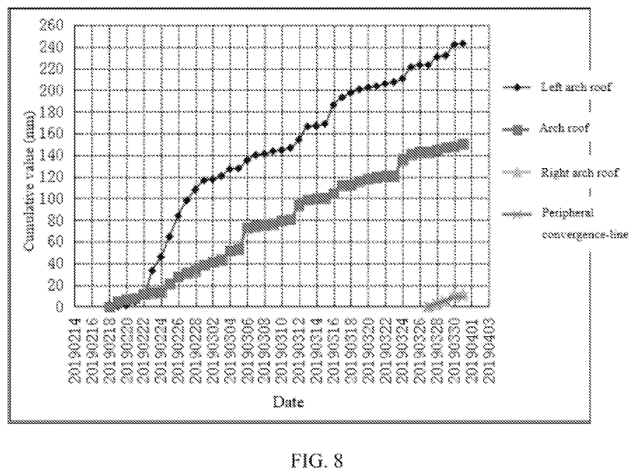

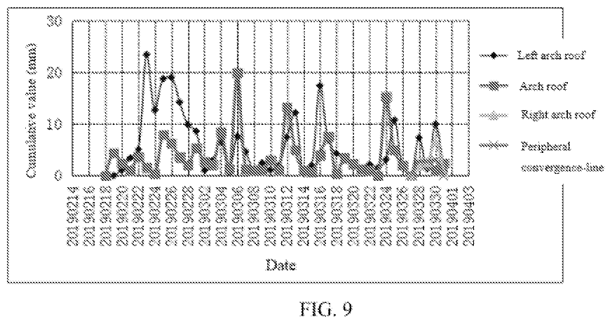

In the Muzhailing Tunnel of the Wei-Wu Railway, monitoring data of construction anchor cable section YK218+455 is shown in FIG. 8 and FIG. 9.

From FIGS. 6-9, it is concluded that the deformation control effect of the pre-stressed anchor cable: a theory from “resistance to deformation” to “deformation control” and from “scattered blocks” to “aggregate” is verified.

The advantages of the present invention are further described below in combination with the positive effect comparison.

Compared with the implementation effect of the traditional method:

Comparisons on implementation effects in the construction process of the Muzhailing Tunnel of the Wei-Wu Railway are as follows:

(1) Load-structure theoretical method:

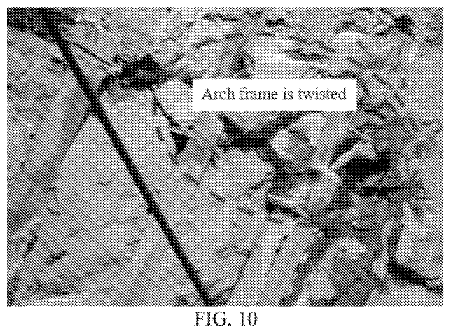

A maximum deformation is 3145 mm (bilateral convergence amount); a maximum convergence rate is 831 mm/d; an arch changing length reaches 530 m; and the efficiency of construction is less than 30 m/month. As shown in the effect diagram in FIG. 10, the arch frame is twisted.

(2) Deconstruction and reconstruction theoretical method:

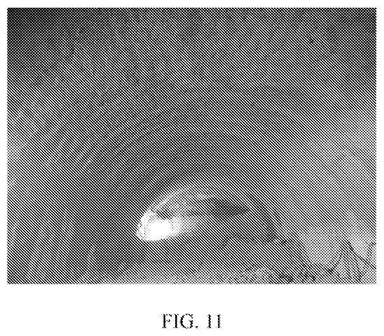

A maximum deformation is 314 mm (single side); a maximum convergence rate is 30 mm/d; the clearance intrusion phenomenon does not occur (in addition to a parameter adjustment section); deformation is controllable; and the efficiency of construction is 50 m/month at present. As shown in FIG. 11, clearance intrusion does not occur.

Conclusion: The technical system of “anchoring followed by supporting plus active deformation control” of the present invention has significant effect on deformation control of high-stress soft rocks.

The above embodiments may be implemented, all or in part, by hardware, software, firmware or any combination thereof. When the above embodiments are implemented, all or in part, in a form of a computer program product, the computer program product comprises one or more computer instructions. When the computer instructions are loaded or executed on a computer, all or in part, processes or functions according to the embodiments of the present invention arc generated. The computer may be a general computer, a special computer, a computer network or other programmable devices. The computer instructions may be stored in the computer readable storage medium, or may be transmitted from one computer readable storage medium to another computer readable storage medium. For example, the computer instructions may be transmitted from one website, a computer, a server or a data center to another website, a computer, a server or a data center wiredly (for example, through a coaxial cable, an optical fiber and a digital subscriber line (DSL)) or wirelessly (for example, through infrared ray, radio, microwave and the like). The computer readable storage medium may be any available media that may be accessed by the computer or a data storage device containing the server, the data center and the like integrated by one or more available media. The available medium may be a magnetic medium (for example, a floppy disk, a hard disk and a tape), an optical medium (for example, DVD), a semiconductor medium (for example, a solid state disk (SSD)) or other media.

The above merely describes specific embodiments of the present invention, but the protection scope of the present invention is not restricted thereto. All modifications, equivalent replacements, improvements and the like made within the technical range disclosed by the present invention by those skilled in the art familiar with the field within the spirit and the principle of the present invention should fall within the protection scope of the present invention.

What is claimed is:

1. A tunnel surrounding rock supporting method based on a tunnel field deconstruction and reconstruction theory, comprising the following steps:
step 1, establishment of a tunnel field: by considering a tunnel as a portion of a rock and soil mass, concepts of a load and surrounding rocks are weakened, and a concept of the tunnel field based on a geological domain is proposed;
step 2, deconstruction of the tunnel field: deterioration of properties of a soil mass, adjustment on soil stress, energy conversion to internal consumed energy and deformation energy, energy absorption by a support body and rock mass storage are conducted; and
step 3, reconstruction of the tunnel field: reconstruction of the tunnel field, comprising active supporting, determination of a change of a stored energy of the rock and soil mass in the tunnel field and energy balance, is conducted.

2. The tunnel surrounding rock supporting method based on the tunnel field deconstruction and reconstruction theory according to claim 1, wherein in step 1, the tunnel field is a region, in which the rock and soil mass (dielectric field) and a stress environment (stress field) within a certain range at the periphery of a tunnel are superposed.

3. The tunnel surrounding rock supporting method based on the tunnel field deconstruction and reconstruction theory according to claim 1, wherein in step 2, the deconstruction of the tunnel field comprises:
(1) deterioration of the properties of the soil mass;
(2) adjustment on the soil stress;
(3) energy conversion to the internal consumed energy, irreversible;
(4) energy conversion to the deformation energy, or energy absorption by the support body; and
(5) rock mass storage.

4. The tunnel surrounding rock supporting method based on the tunnel field deconstruction and reconstruction theory according to claim 1, wherein in step 2, the deconstruction of the tunnel field further comprises:
(1) deterioration of the rock and soil mass in the tunnel field:
due to the uncertainty of perception on the rock and soil mass in the tunnel field, after the rock and soil mass is excavated, both a stress state and the properties of the rock and soil mass in the field are changed; and in addition, such changes further have variability due to different excavation methods;
(2) stress adjustment in the tunnel field; and
(3) change on an energy storage capacity of the tunnel field:
surrounding rocks deform due to deconstruction of the tunnel field, and the phenomena of energy accumulation and release exist before and after deformation of the surrounding rocks; and a stress state is transited to a two-dimensional stress state from a three-dimensional stress state, which causes that a great quantity of deformation energy of the rock and soil mass in the tunnel field is released.

5. The tunnel surrounding rock supporting method based on the tunnel field deconstruction and reconstruction theory according to claim 1, wherein in step 3, the reconstruction of the tunnel field further comprises:
(1) energy is converted to the internal consumed energy-irreversible, naturally released;
(2) after rock mass stored energy-tunnel field is deconstructed, according to the property condition of the rock and soil mass, a part of the energy is continuously stored in the rock and soil mass, and all the rest requires to be released, that is, is converted to the deformation energy or is absorbed by the support body; and
(3) a supporting system is guaranteed to absorb excess energy and be stable; supporting method; a steel arch and reinforcement rows.

6. The tunnel surrounding rock supporting method based on the tunnel field deconstruction and reconstruction theory according to claim 1, wherein in step 3, the reconstruction of the tunnel field further comprises:
(1) active supporting:
a two-dimensional stress field is reconstructed into a three-dimensional stress field;
the rock and soil mass in the tunnel field is improved, and deformation moduli c, φ and E as the physico-mechanical properties are strengthened;
(2) change on the stored energy of the rock and soil mass in the tunnel field:
according to the related theory of rock and soil mechanics, a total energy of the rock and soil mass in the tunnel field is Uₑ, and a following formula is obtained according to the stress environment, in which a rock and soil mass unit is located:
Uₑ=½σ₁●ε₁³+½σ₂●ε₂^{e}+½σ₃●ε₃^{e};
(3) energy balance:
energy changes caused by deconstruction and reconstruction of the tunnel field comprise:
1) the internal consumed energy of the rock and soil mass is U_{d} and is irreversible;
2) for the deformation energy of the rock and soil mass in the tunnel field, under the synergistic effect of the support body, a part of the deformation energy is absorbed and digested by the support body:
U_{support body}=ΣₗⁿUᵢ^{e};
3) the rest deformation energy is stored in the rock and soil mass in the tunnel field U′ₑ:
U′ₑ=½σ′₁●ε₁^{e}+½σ₂●ε₂^{e}+½σ₃●ε₃^{e};
4) according to the energy balance principle:
Uₑ=U_{d}+U_{support body}+U′ₑ.

7. A tunnel surrounding rock supporting system based on a tunnel field deconstruction and reconstruction theory applying the tunnel surrounding rock supporting method based on the tunnel field deconstruction and reconstruction theory according to claim 6, comprising:
a tunnel field establishing module for considering a tunnel as a portion of a rock and soil mass, weakening concepts of a “load” and “surrounding rocks”, and then proposing a concept of the tunnel field based on a geological domain;
a tunnel field deconstruction module for conducting deterioration of properties of a soil mass, adjustment on soil stress, energy conversion to internal consumed energy and deformation energy, energy absorption by a support body and rock mass storage; and
a tunnel field reconstruction module for conducting reconstruction of the tunnel field, comprising active supporting, determination of a change of a stored energy of the rock and soil mass in the tunnel field and energy balance.

8. A computer readable storage medium, storing instructions, wherein when the instructions are operated on a computer, the computer applies the tunnel surrounding rock supporting system based on the tunnel field deconstruction and reconstruction theory according to claim 7.
